(19) United States
(12) Patent Application Publication
(10) Pub. No.: US 2012/0177565 A1
(43) Pub. Date: Jul. 12, 2012

(54) METHOD FOR MAKING A CONDUCTIVE TIN DIOXIDE POWDER

(75) Inventors: Ming-Shyong Tsai, Tainan City (TW); Tian-Shih Wang, Miaoli County (TW)

(73) Assignee: SOUTHERN TAIWAN UNIVERSITY, Tainan City (TW)

(21) Appl. No.: 12/986,723

(22) Filed: Jan. 7, 2011

(51) Int. Cl. C01G 19/02

(52) U.S. Cl. 423/618

(57) ABSTRACT

A method for making a conductive tin dioxide powder includes: reacting a tin salt solution with a base so as to form a precipitate of a tin oxide precursor; and drying the tin oxide precursor and subjecting the tin oxide precursor to calcination under a reducing atmosphere at an elevated temperature so as to form the conductive tin dioxide powder.

### BACKGROUND OF THE INVENTION

1. Field of the Invention

The invention relates to a method for making a conductive to dioxide powder, more particularly to a method involving calcining a tin oxide precursor under a reducing atmosphere for making a conductive tin dioxide powder.

2. Description of the Related Art

Conductive tin dioxide powders can be mixed with an organic resin or an inorganic binder to form a conductive film that is useful for applications, such as a transparent conductive film for an optoelectronic, an anti-static film, an anti-electromagnetic film, or an anti-infrared film.

U.S. Pat. No. 4,246,143 discloses a conventional method of ma king a Sb-doped conductive tin dioxide powder. The method includes the step of calcining a mixture of a tin salt and an antimony compound under an air atmosphere at an elevated temperature, U.S. Pat. No. 5,569,412 discloses another conventional method of making a Ta-, Nb-, or P-doped conductive tin dioxide powder. The method includes the step of calcining a mixture of a tin salt and a tantalum, niobium or phosphorus compound under an inert atmosphere at an elevated temperature. The dopants required for making the conductive tin dioxide powder of the aforementioned patents can result in a decrease in the transparency and an undesired light color of the conductive tin dioxide powder thus formed.

### SUMMARY OF THE INVENTION

Therefore, the object of the present invention is to provide a method for making a conductive tin dioxide powder that can overcome the aforesaid drawback associated with the prior art.

According to the present invention, there is provided a method for making a conductive tin dioxide powder. The method comprises: reacting a tin salt solution with abase so as to form a precipitate of a tin oxide precursor; and drying the tin oxide precursor and subjecting the tin oxide precursor to calcination under a reducing atmosphere at an elevated temperature so as to form the conductive tin dioxide powder.

### BRIEF DESCRIPTION OF THE DRAWING

Other features and advantages of the present invention will become apparent in the following detailed description of the preferred embodiment with reference to the accompanying drawing, of which:

FIG. 1 is an XRD analytic diagram showing the crystal structures of different tin dioxide powders calcined at different temperatures according to the method of this invention.

### DETAILED DESCRIPTION OF THE PREFERRED EMBODIMENT

The preferred embodiment of the method for making a conductive tin dioxide powder includes the steps of: reacting a tin salt solution with a base so as to form a precipitate of a tin oxide precursor; washing the precipitate of the tin oxide precursor using de-ionized water so as to remove impurities contained in the precipitate of the tin oxide precursor; and drying the tin oxide precursor after the washing step and subjecting the dried tin oxide precursor to calcination under a reducing atmosphere at an elevated temperature so as to form the conductive tin dioxide powder.

Preferably, the reducing atmosphere under which the calcination of the tin oxide precursor is performed contains a reducing gas selected from carbon monoxide, hydrogen, or a combination thereof. When carbon monoxide is used as the reducing gas of the reducing atmosphere, the reducing gas can be generated by calcining the tin oxide precursor together with a carbon black powder in a closed space.

The tin salt solution includes water and a tin salt dissolved in the water. Preferably, the tin salt is selected from two-valence tin chloride or four-valence tin chloride.

Preferably, the base is selected from NH₄OH, KOH, or NaOH, or an organic base capable of reacting with the tin salt solution.

The calcination of the tin oxide precursor is preferably performed at a temperature greater than 300° C., and more preferably ranging from 400° C. to 800° C.

The tin salt solution is preferably maintained at a pH value lower than 6 during reaction of the tin salt solution with the base, more preferably at a pH value lower than 3, and most preferably at a pH value ranging from 1.5 to 3.

The following Examples and Comparative Example are provided to illustrate the merits of the preferred embodiment of the invention, and should not be construed as limiting the scope of the invention.

### Example 1

### Preparation of Tin Oxide Powder

100 parts by weight of SnCl₄.5H₂O were dissolved in water to form a 0.3M aqueous solution. A 1M NH₄OH solution was added to and reacted with the aqueous solution to form a precipitate of a tin oxide precursor. The pH of the aqueous solution was adjusted at about 2 during the reaction of the aqueous solution with the NH₄OH solution. The precipitate was collected and was washed with de-ionized water several times to ensure complete removal of impurities attached to the precipitate. The cleaned precipitate was dried at 110° C., and was subsequently calcined together with a carbon black powder in a closed oven at 400° C. for one hour so as to form a transparent white powder having a particle size of less than 10 nm.

### Examples 2-5

Preparations of tin oxide powders of Examples 2-5 are similar to that of Example 1, except that the calcining temperatures for Examples 2-5 are 500° C., 600° C., 700° C., and 800° C., respectively.

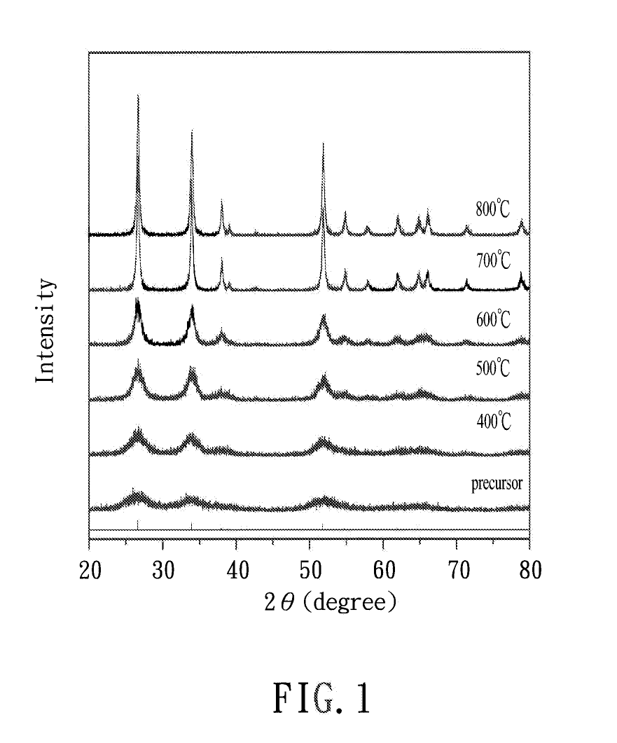

FIG. 1 is an XRD analytic diagram showing the crystal structures of the tin dioxide powders of Examples 1-5 and the tin oxide precursor of Example 1.

### Comparative Example

Preparation of tin oxide powder of Comparative Example is similar to that of Example 3 (calcining at 600° C. except that the tin oxide precursor of Comparative Example was calcined under a non-reducing atmosphere, i.e., without introducing a reducing gas or placing a carbonaceous material in the closed oven,

### Performance Test

The resistivities of the tin oxide powders of Examples 1-5 and Comparative Example were measured using the measuring method disclosed in U.S. Pat. No. 6,221,144. In the measuring, 0.32 g of the tin oxide powder of each of Examples 1-5 and Comparative Example was compacted between two metal dies (each having a diameter of 1.6 cm) in a plastic mold under an elevated pressure. The resistance and the length between two ends of the tin oxide powder pressed in this way were measured. The resistivity ζ of the tin oxide powder is determined by the following relationship:

$$ζ = R \frac{{π ( \frac{d}{2} )}^{2}}{L} [ Ω \cdot cm ]$$

wherein L is the length between the two ends of the pressed tin oxide powder, d is the diameter of the metal dies, and R is the measured resistance between the two ends of the pressed tin oxide powder.

Table 1 shows the determined resistivities of the tin oxide powders of Examples 1-5 pressed under a pressure of 3.2 Kg/cm².

TABLE 1

| | Example 1 | Example 2 | Example 3 | Example 4 | Example 5 |
|---|---|---|---|---|---|
| calcining | 400 | 500 | 600 | 700 | 800 |
| temperature | | | | | |
| ° C. | | | | | |
| resistivity | 19400 | 222 | 40 | 330 | 700 |
| Ωcm | | | | | |

Table 2 shows the determined resistivities of the tin oxide powders of Example 3 and Comparative Example pressed under a pressure of 100 Kg/cm².

TABLE 2

| | | Comparative |
|---|---|---|
| | Example 3 | Example |
| calcining | 600 | 600 |
| temperature | | |
| ° C. | | |
| resistivity | 0.23 | no current can |
| Ωcm | | be detected |

The results shown in Tables 1 and 2 demonstrate that the method of this invention is capable of preparing highly conductive tin oxide powder and that a criticality at about 600° C. is found in the relationship between the determined resistivity and the calcining temperature for Examples 1-5. The performance test of Comparative Example shows that the tin oxide powder thus formed is non-conductive.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A method for making a conductive tin dioxide powder, comprising:
reacting a tin salt solution with a base so as to form a precipitate of a tin oxide precursor; and
drying the tin oxide precursor and subjecting the tin oxide precursor to calcination under a reducing atmosphere at an elevated temperature so as to form the conductive tin dioxide powder.

2. The method of claim 1, wherein the reducing atmosphere under which the calcination of the tin oxide precursor is performed contains a reducing gas selected from carbon monoxide, hydrogen, or a combination thereof.

3. The method of claim 2, wherein when carbon monoxide is used as the reducing gas of the reducing atmosphere, the reducing gas is generated by calcining the tin oxide precursor together with a carbon black powder in a closed space.

4. The method of claim 1, wherein the tin salt solution includes water and a tin salt dissolved in the water, the tin salt being selected from two-valence tin chloride or four-valence tin chloride.

5. The method of claim 1, wherein the base is selected from NH₄OH, KOH, or NaOH, or an organic base capable of reacting with the tin salt solution.

6. The method of claim 1, wherein the calcination of the tin oxide precursor is performed at a temperature greater than 300° C.

7. The method of claim 6, wherein the calcination of the tin oxide precursor is performed at a temperature ranging from 400° C. to 800° C.

8. The method of claim 1, wherein the tin salt solution is maintained at a pH value lower than 6 during reaction of the tin salt solution with the base.

9. The method of claim 8, wherein the tin salt solution is maintained at a pH value ranging from 1.5 to 3 during reaction of the tin salt solution with the base.

10. The method of claim 1, further comprising washing the precipitate of the tin oxide precursor using de-ionized water prior to the drying of the tin oxide precursor so as to remove impurities contained in the precipitate of the tin oxide precursor.
